(19) United States
(12) Patent Application Publication
(10) Pub. No.: US 2024/0286038 A1
(43) Pub. Date: Aug. 29, 2024

(54) Method And Apparatus Of Dynamic Diegetic Audio Generation

(71) Applicant: Sony Interactive Entertainment Europe Limited, London (GB)

(72) Inventor: Philip Cockram, London (GB)

(73) Assignee: Sony Interactive Entertainment Europe Limited, London (GB)

(21) Appl. No.: 18/587,071

(22) Filed: Feb. 26, 2024

(30) Foreign Application Priority Data
Feb. 27, 2023 (GB) 2302781.6

(51) Int. Cl. A63F 13/54

(52) U.S. Cl. CPC A63F 13/54; A63F 2300/6081

(57) ABSTRACT

The invention provides a computer-implemented method of determining and generating diegetic audio originating from a virtual event in a virtual gaming environment, the virtual gaming environment comprising a user avatar and a virtual fluid medium, and the virtual event comprising a first virtual object moving in the virtual fluid medium, the method comprising the steps of: obtaining bulk properties and the virtual domain of the virtual fluid medium; obtaining physical properties and kinematic properties of a first virtual object moving in the virtual domain of the virtual fluid medium; obtaining a physics model based on the bulk properties, the virtual domain, the physical properties, and the kinematic properties; obtaining outputs from the physics model; determining the diegetic audio originating from the virtual event based on the outputs from the physics model; and generating the diegetic audio originating from the virtual event.

### CROSS-REFERENCE TO RELATED APPLICATION

The present application claims priority from United Kingdom Patent Application No. GB2302781.6, filed Feb. 27, 2023, the disclosure of which is hereby incorporated herein by reference.

### FIELD OF THE INVENTION

The invention relates to a dynamic method of diegetic audio generation in a video gaming environment.

### BACKGROUND

In a video gaming setting, audio is categorised as being diegetic or nondiegetic, where diegetic audio refers to sounds that originate from a source within a video gaming environment and nondiegetic audio refers to sounds that originate from a source external to a video gaming environment. Examples of diegetic audio include wind rustling through virtual leaves; a non-player character (NPC) dialogue; and an arrow whistling past a user avatar's virtual ears. Examples of nondiegetic audio include background music; voiceovers; and user interface (UI) sounds.

In general, diegetic audio is pre-recorded and then manually assigned to the relevant virtual in-game events by a programmer working inside a specialised integrated development environment. Any processing on such an audio file to adjust it to a particular in-game scenario, or to adapt it in any other way, must be done manually before it may be assigned. As such, each audio file must be separately recorded and processed during development for every conceivable diegetic audio-generating virtual event.

Currently, these methods of developing diegetic audio have a number of problems. For example, the recording, processing, and assigning of diegetic audio files to the correct in-game events take significant time and the end results, depending on the specific diegetic audio-generating events, often lack realism and situational accuracy when heard by a user during gameplay.

With the expansion of virtual reality (VR) games, augmented reality (AR) games and the like, which require more processing power than previous video game applications there is an urgent need in the art to address the efficiency of generation and realism of perception of diegetic audio in video game development.

### SUMMARY

An object of the invention disclosed herein is to eliminate the foregoing drawbacks of current diegetic audio generation by implementing a method of dynamically generating diegetic audio during gameplay, particularly those sounds relating to fluid-mechanical events. This is achieved by modelling the audio computationally as perturbations to an ambient fluid medium originating from a virtual location of such an event within the virtual gaming environment. It is then possible to process the modelled perturbations such that they sound more realistic to a user at their given virtual distance and orientation from the virtual location of the given diegetic audio-generating event. The accuracy and realism of the diegetic sound associated with a virtual object moving through the virtual gaming environment is thereby increased.

In a first aspect of the invention, there is provided a computer-implemented method of determining and generating diegetic audio originating from a virtual event in a virtual gaming environment, the virtual gaming environment comprising a user avatar and a virtual fluid medium, and the virtual event comprising a first virtual object moving in the virtual fluid medium, the method comprising the steps of: obtaining the bulk properties and the virtual domain of the virtual fluid medium;

obtaining the physical properties and the kinematic properties of a first virtual object moving in the virtual domain of the virtual fluid medium; obtaining a physics model based on the bulk properties, the virtual domain, the physical properties and the kinematic properties; obtaining outputs from the physics model; determining the diegetic audio originating from the virtual event based on the outputs from the physics model; and generating the diegetic audio originating from the virtual event.

In a preferred embodiment of the first aspect, the outputs from the physics model comprise virtual fluid perturbations, the perturbations being represented by at least one of: an acoustic pressure, a sound wave speed, and a sound wave frequency.

In a preferred embodiment of the first aspect, the step of determining the diegetic audio originating from the virtual event comprises: mapping, by a wave generation function, the virtual fluid perturbations output from the physics model to an audio signal.

In a preferred embodiment of the first aspect, before the step of obtaining the physical properties and the kinematic properties of the first virtual object, the method further comprises: dividing the obtained virtual domain into a mesh, the mesh comprising a plurality of cells.

In a preferred embodiment of the first aspect, the step of obtaining outputs from the physics model comprises: implementing the physics model for each cell of at least a relevant subset of the plurality of cells, the relevant subset of cells corresponding to the auditory field of the user avatar.

In a preferred embodiment of the first aspect, the method involves an iterative process, and wherein, before the step of obtaining outputs from a physics model in a current iteration, the method further comprises the steps of: obtaining outputs from the physics model from a previous iteration; and obtaining a physics model based on the obtained outputs from the physics model from the previous iteration in addition to the bulk properties, the virtual domain, the physical properties, and the kinematic properties.

In a preferred embodiment of the first aspect, the step of obtaining outputs from the physics model in a current iteration further comprises: implementing the physics model for each cell of a first subset of the plurality of cells, the first subset of cells being in direct contact with a mesh representation of the first virtual object; and implementing the physics model for each further subset of the plurality of cells, the each further subset of cells being in direct contact with each previous subset of cells, until the outputs from the physics model are obtained for each cell of a second subset of the plurality of cells, the second subset of cells being in direct contact with a mesh representation of the user avatar.

In a preferred embodiment of the first aspect, the steps of: determining the diegetic audio originating from the virtual event based on the outputs from the physics; and

generating the diegetic audio originating from the virtual event, are performed when at least one of the properties of the first virtual object and/or the virtual fluid medium reach a threshold value or values.

In a preferred embodiment of the first aspect, the steps of: determining the diegetic audio originating from the virtual event based on the outputs from the physics model; and generating the diegetic audio originating from the virtual event, are omitted when the at least one of the properties of the first virtual object and/or the virtual fluid medium does not reach a threshold value or values.

In a preferred embodiment of the first aspect, the method further comprises the steps of: applying a head-related transfer function (HRTF) to the diegetic audio originating from the virtual event; and generating 3D diegetic audio originating from the virtual event.

In a preferred embodiment of the first aspect, before the step of obtaining a physics model, the method further comprises the steps of: obtaining the acoustic properties of the virtual domain of the virtual fluid medium; and obtaining a physics model based on the acoustic properties in addition to the bulk properties, the virtual domain, the physical properties, and the kinematic properties.

In a preferred embodiment of the first aspect, the step of generating the diegetic audio originating from the virtual event is performed by an audio generation device.

In a preferred embodiment of the first aspect, the method is performed dynamically during gameplay.

In a preferred embodiment of the first aspect, the physics model is a computational fluid dynamics (CFD) model.

In a preferred embodiment of the first aspect, the virtual fluid medium represents one of: air, water, an airless gas, and a non-aqueous liquid.

In a preferred embodiment of the first aspect, the bulk properties of the virtual fluid medium represent at least one of: a viscosity, a fluid mass density, a specific gravity, a molecular weight, an ambient pressure, and a temperature.

In a preferred embodiment of the first aspect, the virtual domain of the virtual fluid medium represents at least one of: a fluid volume, and a set of virtual fluid medium boundaries.

In a preferred embodiment of the first aspect, the physical properties of the first virtual object represent at least one of: an object mass density, an object volume, and a weight.

In a preferred embodiment of the first aspect, the kinematic properties of the first virtual object represent at least one of: a velocity, an acceleration, a heading vector, and a position with respect to the user avatar.

In a preferred embodiment of the first aspect, the acoustic properties of the virtual domain of the virtual fluid medium comprise at least one of: a reverberation time,
a Doppler effect parameter, an acoustic damping factor, an acoustic absorptivity, and an acoustic reflectivity.

The features of the preferred embodiments described in relation to the first aspect of the invention may equally be implemented in the following second and thirst aspects according to the invention.

In a second aspect of the invention, there is provided an apparatus comprising a processing unit configured to determine and generate diegetic audio originating from a virtual event in a virtual gaming environment according to any method described herein.

In a third aspect of the invention, there is provided a computer program comprising instructions that, when executed, cause the computer to carry out the steps of any method described herein.

### BRIEF DESCRIPTION OF THE DRAWINGS

Exemplary embodiments of the invention will now be described by way of example, with reference to the accompanying drawings, wherein:

FIG. 1 illustrates in schematic form a virtual gaming environment comprising a user avatar and a first virtual object moving in a virtual fluid medium.

FIG. 2 illustrates in schematic form a user playing a video game.

FIG. 3 illustrates in schematic form a computing device comprising a processing unit(s).

### DETAILED DESCRIPTION

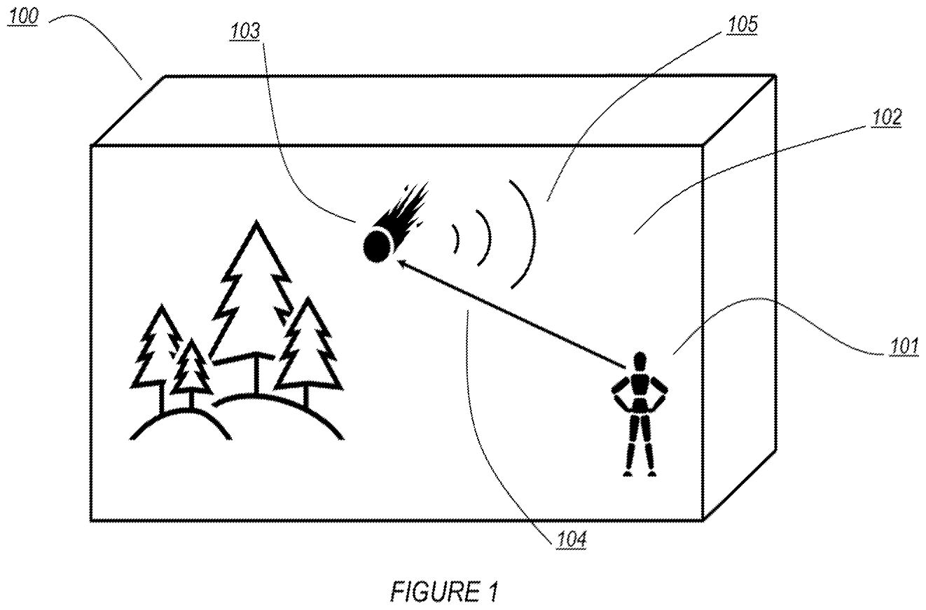

Referring to FIG. 1, there is provided an exemplar virtual gaming environment 100 comprising a user avatar 101 and a virtual fluid medium 102.

The virtual gaming environment 100 may represent any gaming environment having a virtual aspect to it. For example, a fully virtual gaming environment, that is, a VR environment; a hybrid virtual gaming environment that superimposes a virtual component over a real-world component, that is, an AR environment; and the like.

Further, the virtual gaming environment 100 may be part of a metaverse comprising multiple distinct virtual environments. For example, the metaverse may correspond to a particular ecosystem, for example, the PlayStation® ecosystem, and the virtual gaming environment 100 within the metaverse may correspond to an individual video games; a levels within a game; a particular match or another form of cooperative play; and the like. The virtual gaming environment 100 may be a one-dimensional (1D), two-dimensional (2D) or three-dimensional (3D) virtual space.

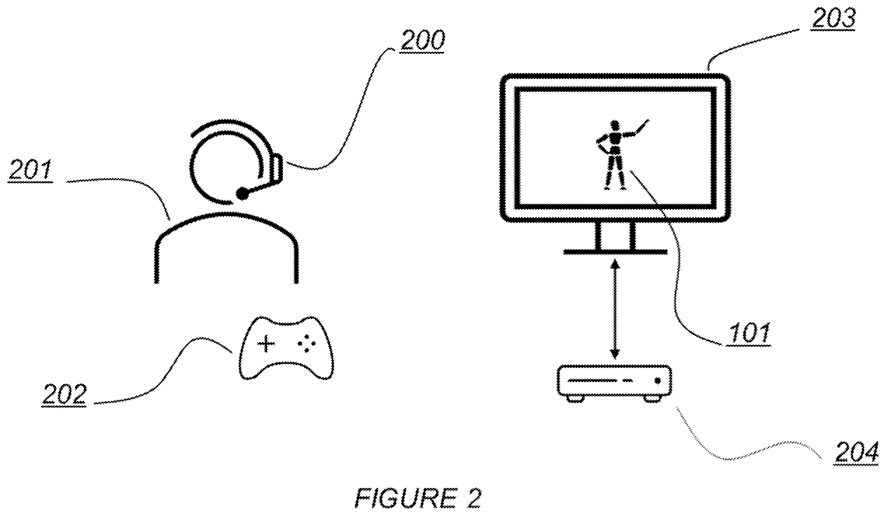

The user avatar 101 (for example, a ‘player character’) may represent a user 201 (as illustrated in FIG. 2) in a virtual form when within the virtual gaming environment 100. The user 201 is typically able to direct their associated user avatar 101 to carry out actions such as moving around the virtual gaming environment 100; interacting with virtual objects and other avatars (for example, NPCs or other users' player characters) that are also present in the virtual environment; and the like. The virtual gaming environment 100 comprises at least an audio component and typically also a visual component. The user avatar 101 may have virtual ears and virtual eyes that may be used to define a respective auditory field and visual field in a (virtual) region around the user avatar 101, that is, that which the user 201 associated with the user avatar 101 may hear and see of the respective audio and visual components of the virtual gaming environment 100.

In the illustrated example, there is a single user avatar 101 shown. However, it will be appreciated that multiple users may experience the virtual gaming environment 100 through multiple respective user avatars when said users are physically located proximate to one another, for example, in the same room. This is often referred to as ‘local co-op play’, ‘local multiplayer’, and the like, in the example of a video game. Further, it will be appreciated that the virtual gaming environment 100 may also comprise multiple user avatars 101 associated with respective multiple users 201 when physically located at a distance from one another, for example, during ‘online multiplayer’ and the like.

The virtual fluid medium 102 may represent any liquid, gas, or other fluid having a virtual aspect to it and which is within the virtual gaming environment 100. The virtual fluid medium typically represents air, that is, the virtual fluid medium 102 is a virtual air medium as in the illustrated example. Alternatively, the virtual fluid medium 102 may represent, for example, water, lava, steam, a noxious gas, an airless gas, a non-aqueous liquid, or the like. Virtual objects within the virtual gaming environment 100 including, but not limited to, the user avatar 101, may be able to move in the given virtual fluid medium 102.

The user 201 associated with the user avatar 101 may see and hear the respective visual and audio components of the virtual gaming environment 100 as described herein. The audio component of the virtual gaming environment 100 comprises at least a diegetic audio component and optionally a nondiegetic audio component. The respective visual and audio components of the virtual gaming environment 100 may be perceived by the user 201 associated with the user avatar 101 differently in different virtual fluid media 102. For example, diegetic audio travelling as a soundwave 105 in a virtual air medium may be heard by the user 201 associated with the user avatar 101 more clearly than the same audio when heard travelling in a virtual water medium. Similarly, a virtual object may appear to the user 201 associated with the user avatar 101 differently in different virtual fluid media. It should be noted that a virtual object capable of producing discernible diegetic audio, that is, auditorily discernible to the user 201 associated with the avatar 101, will be known hereon as a ‘first virtual object’ 103. Further, the method described herein comprises the steps of determining the diegetic audio originating from the virtual event based on the outputs from the physics and of generating the diegetic audio originating from the virtual event when at least one of the properties of the first virtual object 103 and/or the virtual fluid medium 102 reach a threshold value or values. These steps may be omitted when the at least one of the properties of the first virtual object 103 and/or the virtual fluid medium 102 does not reach this threshold value or values.

The virtual fluid medium 102 typically has bulk properties associated with it. The bulk properties of the virtual fluid medium 102 may represent the corresponding bulk properties of the fluid which, in turn, the virtual fluid medium 102 represents. Bulk, when used herein, may be understood to mean consistent over all or parts of the virtual domain. Example bulk properties of the virtual fluid medium 102 may represent viscosity, fluid mass density, specific gravity, molecular weight, ambient pressure, and temperature. In the illustrated example, the bulk properties of the virtual air medium shown therein may therefore represent an air viscosity, an air mass density, an air specific gravity, an air molecular weight, an ambient air pressure, and an air temperature.

The virtual fluid medium 102 typically also has a computational domain representing a set of virtual fluid medium boundaries, wherein the boundaries are typically spatial. Such a domain may be further representative of the fluid volume, region, or area of the virtual gaming environment 100 through which the virtual fluid medium 102 pervades, that is, a domain of the virtual gaming environment 100 wherein the virtual fluid medium 102 is represented virtually. Such a domain is also referred to herein as the ‘virtual domain’. In the illustrated example, the virtual domain is defined by the cuboidal boundary shown at the perimeter of the virtual gaming environment 100. However, the invention is not limited in this regard as the virtual domain may be defined by any shape contemplated by a skilled person in the art. For example, the virtual domain may comprise the internal volume of a building, wherein the boundaries are associated with the internal walls, floor and ceiling of the building. The shape of the virtual domain may also be defined, in part, by objects present in the gameplay environment. The virtual domain of the virtual fluid medium 102 may have acoustic properties representing the corresponding acoustic properties of the spatial boundaries which, in turn, the virtual domain may represent. Example acoustic properties of the virtual domain may represent a level of reverberation (or ‘reverberation time’); a Doppler effect parameter; an acoustic damping coefficient or factor; an acoustic absorptivity; an acoustic reflectivity; and the like.

Referring again to FIG. 1, there is provided an exemplar virtual event in the virtual gaming environment 100 wherefrom diegetic audio originates represented, by way of example, as soundwaves 105. The virtual event comprises a first virtual object 103 moving in the virtual fluid medium 102 and displaced from the user avatar 101 by a position vector 104. Such virtual events should be distinguished from nondiegetic audio-generating virtual events which are associated with, for example, in-game music.

The first virtual object 103 may be any virtual object capable of producing discernible diegetic audio, that is, auditorily discernible to the user 201 associated with the avatar 101. In the illustrated example, the first virtual object 103 is a meteor moving within the visual and auditory fields of the user avatar 101. The first virtual object 103 typically has physical properties associated with it. The physical properties of the first virtual object 103 may represent the corresponding physical properties of the object which, in turn, the first virtual object 103 represents. Example physical properties of the first virtual object 103 may represent an object mass density, an object volume, a weight, and other physical properties known per se in the art. In the illustrated example, the physical properties of the meteor shown therein may therefore represent a meteor mass density; a meteor volume; a meteor weight; and the like.

Further, the first virtual object 103 typically has kinematic properties associated with it. The kinematic properties of the first virtual object 103 may represent the corresponding kinematic properties of the object which, in turn, the first virtual object 103 represents. Example kinematic properties of the first virtual object 103 may represent a velocity; an acceleration; a heading vector; a position with respect to the user avatar; and the like. In the illustrated example, the kinematic properties of the meteor shown therein may therefore represent a meteor velocity; a meteor acceleration; a meteor heading vector; a meteor position with respect to the user avatar 101 (in the illustrated example, the first virtual object 103, that is, the meteor, is displaced from the user avatar 101 by a position vector 104); and the like.

Referring to FIG. 2, there is provided an exemplar apparatus arranged to determine and generate diegetic audio originating from a virtual event in the virtual gaming environment 100 that may be perceived by the user 201 associated with the user avatar 101 (as illustrated in FIG. 1). The apparatus comprises a computing device 204; an audio generation device 200; and, optionally, a display device 203 and a controller 202.

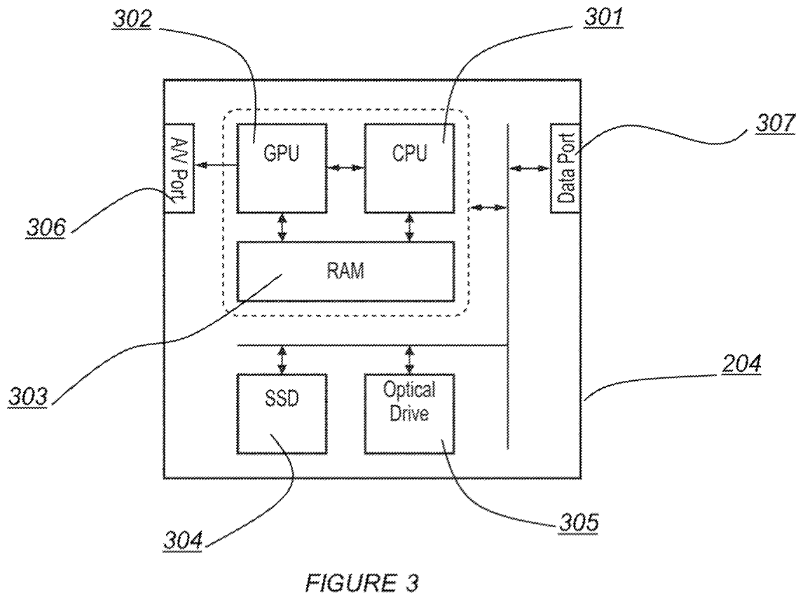

The computing device 204 comprises a processing unit(s) (as illustrated in FIG. 3) capable of performing audio processing and, in particular, of determining the diegetic audio originating from a virtual event by the method described herein. The processing unit may be any type of processor capable of performing the invention, and may be a Tempest Engine audio processing unit of the type known per se in the art. As such, the processing unit of the computing device 204 may execute software code to enable the user 201 to perceive and experience the virtual gaming environment 100. Further, the required audio processing may occur in any capable component(s) of the computing device 204, or any combinations thereof. It should be noted that such an component(s) of the computing device 204, or any combinations thereof, will be known hereon as the ‘processing unit’.

In the illustrated example, computing device 204 is a game console. The game console may be of any type known or developed in future and in particular may be from the Sony PlayStation® series of consoles. However, the invention is not limited in this regard. Computing device 204 may alternatively be a virtual assistant module; a cloud-based computing resource; a laptop; a desktop computer; a tablet computer; a mobile phone; an in-vehicle computation unit; and the like.

Computing device 204 is communicably coupled to the (optional) audio generation device 200. The coupling may be wired or wireless and may involve an intermediate network, for example, the internet or a local/personal area network. The audio generation device 200 is typically configured to generate and output the audio component of the virtual gaming environment 100 including, but not limited to, the diegetic audio originating from a virtual event as determined by the method described herein, based on received audio signals that are output from the computing device 204.

In the illustrated example, the audio generation device 200 is a headset having loudspeakers and a microphone. However, the invention is not limited in this regard. Audio generation unit 200 may alternatively be a speaker which may be embedded in another device, for example, a television speaker; laptop speaker; tablet speaker; virtual assistant module speaker; in-vehicle speaker; and the like. More than one speaker may be present, for example, in a surround sound-type setup. The speaker or speakers may be portable, for example, a Bluetooth® sound bar. The audio generation device 200 may be further configured to detect and receive audio, for example, in the form of speech or ‘voicechat’, at the microphone and process said audio in a processing unit(s) of the computing device 204 for integration into the virtual gaming environment 100.

Computing device 204 is communicably coupled to the (optional) display device 203. The coupling may be wired or wireless and may involve an intermediate network, for example, the internet or a local/personal area network. The display device 203 is typically configured to generate and output the visual component of the virtual gaming environment 100 based on received visual signals output from the computing device 204.

In the illustrated example, display device 203 is a television screen. However, the invention is not limited in this regard. Display device 203 may alternatively be a virtual reality headset worn by the user 201; a display of a laptop; a display of a tablet computer; a display of a desktop computer; a display of a mobile phone; a holographic projector; an in-vehicle display such as a satellite navigation system display or a cinema screen; and the like. In some examples, the visual component of the virtual gaming environment 100, and similarly the display device 203, may be omitted entirely, such as in an audio-only AR environment or in a virtual assistant application.

Computing device 204 is communicably coupled to the (optional) controller 202. The coupling may be wired or wireless and may involve an intermediate network, for example, the internet or a local/personal area network. The controller 202 may assist the user 201 in directing their associated user avatar 101 to carry out actions such as moving around the virtual gaming environment 100; interacting with virtual objects and other avatars that are also present in the virtual environment; and the like. In the illustrated example, the controller 202 is a game console controller. The controller 202 may be of any type known or developed in future, and in particular may be from the Sony PlayStation® series of controllers. However, the invention is not limited in this regard. The controller 202 may take many alternative forms including, but not limited to, a voice command interface, a touchscreen, a computer mouse and/or keyboard, a gesture recognition interface, and the like.

Referring to FIG. 3, there is provided an exemplar computing device 204 comprising components which include, but are not limited to, a computer processing unit (CPU) 301; a graphics processing unit (GPU) 302; a random-access memory (RAM) 303; a solid-state drive (SSD) 304; an optical drive 305; an audio-visual (A/V) port 306; and a data port 307.

The computing device 204 comprises a processing unit capable of performing audio processing and, in particular, of determining diegetic audio originating from a virtual event by the method described herein. As such, a processing unit of the computing device 204 may execute software code to enable the user 201 to perceive and experience the virtual gaming environment 100. The computing device 204 may process audio in any one or combination of the respective components shown in the illustrated example. The required audio processing to determine diegetic audio originating from a virtual event by the method described herein may therefore occur in the CPU 301, the GPU 302, another component of the computing device 204, or any combinations thereof. However, the invention is not limited in this regard. Computing device 204 may alternatively comprise other components known per se in the art or developed in future which are capable of performing audio processing and, in particular, of determining diegetic audio by the method described herein.

The processing unit is configured to obtain and implement a physics model relating to the virtual event with respect to the user avatar 101. The process of obtaining and implementing the physics model may occur dynamically (that is, in real-time during gameplay) within the processing unit. The physics model comprises the set of fluid dynamics equations and the kinematic/motion equations required to model and thereby determine diegetic audio originating from a virtual event. Such equations may comprise the Bernoulli equation; the Euler equations; the Navier-Stokes equations; other equations or systems thereof known per se in the field of continuum mechanics; equations or systems thereof of rectilinear or curvilinear motion; other kinematic/motion equations associated with the first virtual object 103 moving in the virtual fluid medium 102 known per se in the field of kinematics; and the like. The physics model is typically a generalised computational fluid dynamics (CFD) model running on the CPU 301, the GPU 302, or any combinations thereof. However, the invention is not limited in this regard. The physics model may alternatively be, or additionally include a numerical simulation model; an algorithmic simulation model; any analytical fluid mechanics model; a mesh-based solver; an immersed boundary model; a finite volume solver; a differential equation solver; and the like.

The processing unit is configured to obtain relevant inputs to, that is, for use in, the physics model. The inputs may comprise the variables, properties, parameters, and the like, that are input into the equations of the physics model. The inputs may further comprise other information, properties and data relating to the virtual fluid medium 102 and the virtual event, with respect to the user avatar 101. The initial inputs may be chosen, set and pre-programmed by a game designer during game development or set by the user 201; however, inputs to the physics model may change and update dynamically and/or iteratively during gameplay. The processing unit may then obtain a physics model based on the inputs for the purposes of dynamically determining the diegetic audio originating from the virtual event when considered with respect to the user avatar 101.

Inputs to the physics model typically comprise the bulk properties of the virtual fluid medium 102; the virtual domain of the virtual fluid medium 102, wherein the virtual domain may represent the solution space for the physics model; the physical properties of the first virtual object 103; and the kinematic properties of the first virtual object 103 including, but not limited to, a position with respect to the user avatar 101, as represented in the illustrated example by a position vector 104 which describes the displacement from the user avatar 101 to the first virtual object 103. The acoustic properties of the virtual domain of the virtual fluid medium 102 may optionally be input to the physics model, in addition to the other inputs described herein. In an (optional) iterative process, outputs from the physics model obtained during a previous iteration of the method may optionally be input to the physics model during a later iteration, in addition to the other inputs described herein.

Once the relevant inputs have been obtained by the processing unit, the processing unit is typically configured to divide the obtained virtual domain into a numerical grid array (that is, a ‘mesh’) of discrete cells having a finite size. The mesh may be obtained using a meshing algorithm of the processing unit or otherwise. For example, an improved mesh may also be obtained, in part or in full, using a mesh optimisation algorithm of the processing unit. Such an algorithm may enable the determination, and optionally the removal, of virtual objects in the obtained virtual domain and/or the interiors of said virtual objects which would be physically incapable of producing diegetic audio and/or transmitting a travelling soundwave 105. These virtual objects may include, for example, all static solid objects present in the virtual domain. The obtained mesh may be a 2D or 3D mesh, a structured mesh, an unstructured mesh, a hybrid mesh, or any other mesh of any given density contemplated by a person skilled in the art. It is noted that such a mesh representation may also be obtained by equivalent means for the first virtual object 103 and the user avatar 101. The interactions of cells may be usefully determined using any known numerical solution technique, such as an immersed boundary method.

Once the mesh of the virtual domain has been obtained by the processing unit, the processing unit is then typically configured to implement the physics model for each cell, or a relevant subset of cells, in the mesh. In other words, the processing unit may be configured to solve for, simulate, approximate, or estimate the solutions to equations, or systems thereof, of the physics model for each cell, or a relevant subset of cells, in the mesh. This may involve assigning what is known in the art as a ‘physics collider’, a ‘mesh collider, and/or a ‘dynamic collider’ to each cell in the mesh which may be used to determine the interactions of cells, that is, the change in output of cells following the change in output of neighbouring cells, in an iterative process. The processing unit may thereby implement the physics model over the virtual domain, or a relevant portion thereof. A relevant portion of the virtual domain (and likewise a relevant subset of cells in the mesh), when used herein, may be understood to mean within the auditory field of the user avatar 101.

The physics model may usefully provide outputs associated with virtual fluid perturbations (such as those illustrated by the soundwaves 105 in FIG. 1) originating from the virtual event. The outputs may be obtained for each cell in the mesh, or a relevant subset thereof. The outputs may represent, but are not limited to, the virtual equivalents of an acoustic pressure, a fluid temperature, a sound wave speed, and a sound wave frequency associated with the state of the virtual fluid medium 102 in any given cell in the mesh. This may be an iterative process, that is, outputs from the physics model obtained during a previous iteration of the method may optionally be input to the physics model during a later iteration, in addition to other inputs described herein.

In an exemplar process, initial inputs to the physics model may comprise relevant inputs such as the initial kinematic properties of the first virtual object 103, in particular, the object velocity and acceleration of said first virtual object 103. The initial inputs may be used to determine, by the physics model implementing in the processing unit, the relevant outputs of the cells which are in direct contact with the mesh representation of the first virtual object 103, that is, the cells of the virtual domain which directly interact with the cells of the first virtual object 103. Outputs from these cells of the virtual domain may then be used by the processing unit as inputs to determine the corresponding outputs in further directly contacting cells of the virtual domain in an iterative fashion, thereby modelling variation in the outputs of the physics model and, in particular, the variation in acoustic pressure over the virtual domain, or a relevant portion thereof.

The processing unit therefore obtains a representation (or ‘simulation’) of the virtual domain comprising a mesh, wherein the outputs of the physics model for each relevant cell in the mesh are determined. In other words, the solutions (or estimations thereto) to the relevant fluid dynamics equations and the kinematic/motion equations in each relevant cell in the mesh are determined by the implemented physics model and obtained by the processing unit. The process of implementing the physics model and obtaining outputs therefrom may occur dynamically (that is, in real-time during gameplay) within the processing unit. The outputs of the physics model represent the fluid behaviours of the virtual fluid medium 102 and thereby enable the processing unit to model (or ‘simulate’) the virtual fluid perturbations originating from the first virtual object 103 moving in the virtual fluid medium 102.

The processing unit may use the determined variation in outputs of the physics model over the virtual domain, or a relevant portion thereof, that represent said virtual fluid perturbations to generate the diegetic audio heard by a user 201 associated with a user avatar 101, wherein the mesh representation of said user avatar 101 is positioned at any given cell in the virtual domain when such a virtual event occurs. For example, the processing unit may, by a wave generation function, map the virtual fluid perturbations to an audio signal for outputting using the determined variation in acoustic pressure (and any other relevant outputs from, or indeed inputs to, the physics model), thereby determining the diegetic audio originating from the virtual event. However, the invention is not limited in this regard and a person skilled in the art may use any function capable of mapping the outputs of the physics model in such a way as to produce an audio signal for outputting.

Once the diegetic audio originating from the virtual event has been determined, the processing unit may, by the position of the first virtual object 103 with respect to the user avatar 101, determine the diegetic audio heard by the user 201 associated with the user avatar 101 at the particular location of said user avatar 101 in the virtual domain, that is, at the cell or cells in the mesh that are in direct contract with the mesh representation of the user avatar 101, or a portion thereof (for example, the portion of the mesh representation of the user avatar 101 corresponding to the virtual ears). For example, the processing unit may incorporate what is known in the art as a ‘spatial audio object’ to determine the stream of diegetic audio originating from the virtual event that is arriving, virtually, at the user avatar 101.

It will be appreciated that the diegetic audio originating from a virtual event, wherein the virtual event comprises a virtual object moving in a virtual fluid medium, may not be discernible to the user 201 associated with the user avatar 101. This may be due to the kinematic or physical properties of the virtual object, or the bulk properties of the virtual fluid medium, are such that the diegetic audio is too quiet to be perceived. For example, the virtual fluid medium may be too viscous or the virtual object may be too small or slow such that discernible diegetic audio does not reach the user avatar 101. (Incidentally, such a virtual object would not be considered herein as a ‘first’ virtual object in this particular scenario.) When such a virtual event occurs, the processing unit may be configured to omit the steps of determining the diegetic audio originating from the virtual event based on the outputs from the physics model and of generating the diegetic audio originating from the virtual event.

The processing unit determines diegetic audio originating from a virtual event by the method described herein. The processing unit may also implement a step of applying a Head Related Transfer Function (HRTF) as part of the determination of diegetic audio that is output to the user via the audio generation device 200. An HRTF enables diegetic (and, indeed, nondiegetic) audio to be generated that takes account of the structure of the human head and ear, such that even relatively simple audio generation devices may produce highly realistic 3D (or ‘binaural’) diegetic audio originating from a virtual event. However, the invention is not limited to the user of an HRTF to generate 3D diegetic audio as any equivalent technique known per se in the art may be employed in the alternative.

The methods described herein may be implemented by hardware, software, or any combinations thereof. Where a software implementation is employed to implement an embodiment of the invention or any feature therein, it will be appreciated that such software, and any non-transitory machine-readable storage media by which such software is provided, are also to be considered embodiments of the invention.

The foregoing descriptions are merely exemplary embodiments of the invention and are not intended to limit the protection scope of the invention. Any variation, replacement or other embodiment readily contemplated by a person skilled in the art within the technical scope disclosed in the appended claims shall fall within the protection scope of the invention.

1. A computer-implemented method of determining and generating diegetic audio originating from a virtual event in a virtual gaming environment, the virtual gaming environment comprising a user avatar and a virtual fluid medium, the virtual event comprising a first virtual object moving in the virtual fluid medium, the method comprising:
obtaining bulk properties and a virtual domain of the virtual fluid medium;
obtaining physical properties and kinematic properties of the first virtual object moving in the virtual domain of the virtual fluid medium;
obtaining a physics model based on the bulk properties, the virtual domain, the physical properties, and the kinematic properties;
obtaining outputs from the physics model;
determining the diegetic audio originating from the virtual event based on the outputs from the physics model; and
generating the diegetic audio originating from the virtual event.

2. The method according to claim 1, wherein the physics model comprises a computational fluid dynamics (CFD) model.

3. The method according to claim 1, wherein the outputs from the physics model comprise virtual fluid perturbations, the perturbations being represented by at least one of:
an acoustic pressure,
a sound wave speed, or
a sound wave frequency.

4. The method according to claim 3, wherein determining the diegetic audio originating from the virtual event comprises:
mapping, by a wave generation function, the virtual fluid perturbations output from the physics model to an audio signal.

5. The method according to claim 1, wherein determining the diegetic audio and generating the diegetic audio are performed when at least one of the properties of at least one of the first virtual object or the virtual fluid medium reaches a threshold value.

6. The method according to claim 1, wherein determining the diegetic audio and generating the diegetic audio are omitted when at least one of the properties of at least one of the first virtual object or the virtual fluid medium does not reach a threshold value.

7. The method according to claim 1, wherein the method further comprises:
applying a head-related transfer function (HRTF) to the diegetic audio originating from the virtual event; and
generating 3D diegetic audio originating from the virtual event.

8. The method according to claim 1, further comprising, before obtaining the physics model:
obtaining acoustic properties of the virtual domain of the virtual fluid medium; and
obtaining a physics model based on the acoustic properties in addition to the bulk properties, the virtual domain, the physical properties, and the kinematic properties.

9. The method according to claim 1, further comprising, before obtaining the physical properties and the kinematic properties of the first virtual object:
dividing the virtual domain into a mesh, the mesh comprising a plurality of cells.

10. The method according to claim 9, wherein obtaining outputs from the physics model comprises:
implementing the physics model for each cell of at least a relevant subset of the plurality of cells, the relevant subset of cells corresponding to an auditory field of the user avatar.

11. The method according to claim 1, wherein the method involves an iterative process and further comprises, before obtaining outputs from a physics model in a current iteration:
obtaining outputs from the physics model from a previous iteration; and
obtaining a physics model based on the obtained outputs from the physics model from the previous iteration in addition to the bulk properties, the virtual domain, the physical properties, and the kinematic properties.

12. The method according to claim 11, wherein obtaining outputs from the physics model in a current iteration further comprises:
implementing the physics model for each cell of a first subset of a plurality of cells of a mesh that divides the virtual domain, the first subset of cells being in direct contact with a mesh representation of the first virtual object; and
implementing the physics model for each further subset of the plurality of cells, each further subset of cells being in direct contact with each previous subset of cells, until the outputs from the physics model are obtained for each cell of a second subset of the plurality of cells, the second subset of cells being in direct contact with a mesh representation of the user avatar.

13. The method according to claim 1, wherein generating the diegetic audio originating from the virtual event is performed by an audio generation device.

14. The method according to claim 1, wherein the method is performed dynamically during gameplay.

15. An apparatus comprising a processing unit configured to determine and generate diegetic audio originating from a virtual event in a virtual gaming environment, the virtual gaming environment comprising a user avatar and a virtual fluid medium, the virtual event comprising a first virtual object moving in the virtual fluid medium, the processing unit configured to determine and generate the diegetic audio by:
obtaining bulk properties and a virtual domain of the virtual fluid medium;
obtaining physical properties and kinematic properties of the first virtual object moving in the virtual domain of the virtual fluid medium;
obtaining a physics model based on the bulk properties, the virtual domain, the physical properties, and the kinematic properties;
obtaining outputs from the physics model;
determining the diegetic audio originating from the virtual event based on the outputs from the physics model; and
generating the diegetic audio originating from the virtual event.
